(19) United States
(12) Patent Application Publication
(10) Pub. No.: US 2011/0096328 A1
(43) Pub. Date: Apr. 28, 2011

(54) Multi-Signal Determination of Polarization Dependent Characteristic

(75) Inventors: Clemens Rueck, Bondorf (DE); Hansjoerg Haisch, Altdorf (DE)

(73) Assignee: OSRAM GESELLSCHAFT MIT BESCHRAENKTER HAFTUNG, Munich (DE)

(21) Appl. No.: 10/527,906

(22) PCT Filed: Jul. 25, 2003
(86) PCT No.: PCT/EP2003/050335

§ 371 Date: Jan. 8, 2007

(30) Foreign Application Priority Data
Sep. 13, 2002 (EP) PCT/EP02/10285

(51) Int. Cl. G01J 4/04

(52) U.S. Cl. 356/364

(57) ABSTRACT

A method of determining polarization dependent characteristic of an optical device under test (10) having at least one input and at least one output, comprises the steps of generating and inputting a stimulus signal (4) to each of a plurality of polarization units (27a, 29b, 127c, 129d), setting each of said input stimulus signals into a unique state of polarization, attaching a characteristic identification portion (27, 29, 127, 129) to each of said input and/or polarized stimulus signals, applying said stimulus signal to said device under test (10) for effecting a response signal of said device under test, receiving and identifying (44, 52) each of said characteristic identification portions from said response signal for tracing each of said polarized stimulus signals within said response signal, deriving a polarization dependent characteristic of said device under test from said traced polarized stimulus signals. The method provides a measurement of polarization dependent loss PDL within one shot of a stimulus signal. For such simultaneous measurements couplers (105, 135) are used. Also for polarization mode dispersion PMD.

### BACKGROUND OF THE INVENTION

The present invention relates to the measurement of optical devices having single or multiple ports and comprising one or more optically active or passive components. In particular, the invention relates to a determination of polarization dependent characteristic of these devices.

A method of measuring multi-port optical devices is known from EP-A-1235062. Testing optically active or passive devices exhibiting polarization dependent characteristic has become an increasingly important task in optical communications measurement industry. With ongoing increase of distances in optical transmission communication systems, mechanical stress or temperature induced birefringence, e.g., in optical fibers, are growingly affecting polarization characteristic of a signal that is input to the communication system, i.e. to one or more optical devices. Optical devices affected by polarization changes are among others, e.g., switches, cross-connects, attenuators, fiber optic couplers, filters, isolators, amplifiers, or passive fiber optic transmission lines. Changes in the state of polarization of a signal input to optical devices may result in unwanted signal fluctuations. Characterization of an optical device with respect to polarization therefore is one of the main goals when improving optical transmission systems. A method of measuring polarization mode dispersion (PMD) is known from U.S. Pat. No. 6,144,450.

### SUMMARY OF THE INVENTION

It is an object of the invention to provide an improved testing of optical devices with respect to polarization characteristic. The object is solved by the independent claims. Preferred embodiments are shown by the dependent claims.

An optical device under test (DUT) having at least one input and at least one output is applied with a stimulus signal, which is superimposed with characteristic identification portions, each of said portions being set into a different state of polarization by means of a plurality of polarization units. This stimulus signal is introduced to the system by means of a signal application unit, which—according to a preferred embodiment—may comprise one or more optical signal sources, e.g. a tunable laser source, but the stimulus signal may also be introduced from an external source.

The signal application unit forwards the stimulus signal to each of the plurality of polarization units. Each of said polarization units is designed to set the stimulus signal forwarded from the signal application unit into a unique state of polarization. In particular, a state of polarization set by a first polarization unit differs from another state of polarization set by a second polarization unit.

Polarization units as described in this document may comprise polarization controllers. One known and commonly available product is the Agilent 8169 A polarization controller of the applicant Agilent Technologies. Polarization controllers as being usable in the present system may either be designed to set an incoming optical signal into a fixed state of polarization or may be designed to apply adjustable, variable polarization characteristic to said signal. What is important is, that a single stimulus signal is introduced by the application unit and is applied—or split—towards each of the polarization units, each of said polarization units setting the stimulus signal separately into a unique state of polarization, which differs from that of another polarization unit within the present set.

In order to enable to recover each of the polarized stimulus signals out of a response signal output from the DUT, a characteristic identification portion is attached to each of the polarized stimulus signals. In other words, one modulation unit affecting said identification portion is each associated with one of the polarization units. A characteristic identification portion within said stimulus signal uniquely corresponds to a state of polarization applied to the signal by means of the polarization unit.

In a preferred embodiment, the stimulus signal as being applied by the signal application unit comprises a carrier portion having a carrier frequency. Said modulation unit is designed to apply the characteristic identification portion by means of frequency, amplitude or phase modulation to a stimulus signal. According to this embodiment, the identification portion is represented by mixture frequencies located in side bands of the carrier frequency.

The uniquely polarized and identifiable stimulus signal split towards each of the polarization units is then superimposed for being input to the optical device under test. Accordingly, the superimposed signal comprises a carrier portion having multiple components with differing states of polarization each portion being characterized by one unique frequency.

The DUT to be tested with the stimulus signal provided as explained above may have one or more in- and outputs, and may be embodied as any kind of active or passive optical device. Gain systems such as amplifiers, or fiber optic couplers, filters, attenuators, switches, cross-connects, isolators, etc. or even polarization controllers itself maybe examined with respect to polarization characteristic using the system and the method of the present invention. However, the invention is not restricted to devices as listed above, rather the invention is applicable to any device, or system of devices including long transmission line systems, which exhibit polarization change characteristic, in particular polarization dependent loss, which will be explained in embodiments below.

The response signal associated with the stimulus signal by means of the DUT is received by a signal receiving unit. In a preferred embodiment, the signal receiving unit comprises an optical power meter for measuring the response signal. The signal receiving unit may comprise a semiconductor diode as a sensor element, e.g., InGaAs-diodes for a wavelength range 850-1700 nm, Ge-diodes for 600-1650 nm or Si-diodes for 400-1000 nm.

During transformation of the optical into an electrical signal mixed frequency signals—or so-called beat signals—are generated in the low frequency regime of the side bands of the carrier signal, which have a state of polarization that is not orthogonal with respect to a polarization of a respective other side band signal. The electrical beat signals can now advantageously be separated in the electrical regime by means of suitable electrical filters. By means of appropriate coding, each of the individual frequencies may be associated with one of said states of polarization.

The receiving unit is therefore enabled to trace the identification portion originating from the stimulus signal from within the response signal. Due to the polarization characteristic of the optical device, the polarized identification portions are affected by loss or gain characteristic. With the help of the signal receiving unit, each of the polarized identification portions traced within the response signal can be measured.

According to a preferred embodiment of the invention, the measured values of the polarized identification portions, e.g. the power of each component, is compared each with a value being measured for the same portion with a DUT known not to display a polarization dependent characteristic, e.g. a fiber channel, or else being known prior to entering the device under test. By such a comparison, the loss- or gain-change of the applied states of polarizations (SOPₓ) can be derived. Based on these polarization dependent loss or gain measurements the so-called Mueller-method can be used to evaluate the maximum and minimum signal power and therefrom, e.g., the polarization dependent loss (PDL) or gain (PDG). Such a derivation as well as a detailed analysis is carried out by means of an evaluation unit. The evaluation unit may comprise a PC, workstation or other logical processing unit, the user interface, and/or a memory. A main characteristic of the DUT is the maximum loss-deviation due to polarization change of the input signal maybe represented by the polarization dependent loss PDL (for active optical components, e.g., amplifier a term “positive loss”=gain (PDG) is utilized). The invention becomes most advantageous in a preferred embodiment, according to which the loss characteristic (or gain characteristic) are determined by just analyzing the loss/gain change behavior of four well-defined states of polarization. A matrix, e.g., the so-called Mueller-matrix, is set up relating each of the components of the four states of polarization prior and after passing the DUT to each other. The corresponding linear equation system is then solved by means of the evaluation unit, wherein the polarization dependent loss can easily be represented by the matrix coefficients. An example will be given in the detailed description as provided below.

A main ingredient is that the stimulus signal is split into a plurality of portions, each portion being supplied with an additional identification portion and a unique state of polarization. In the response signal the state of polarization is recovered by means of the identification portion and is then measured. By coincidentally applying, e.g., four or more states of polarization the coefficients can be derived with just one measurement cycle, i.e. a single shot of said stimulus signal. Prior art methods employed serial measurement techniques (in time). Thus, few efforts are necessary; in particular, less time and calibration work is needed to characterize an optical device.

The invention can be partly or entirely embodied or supported by one or more suitable software programs, which can be stored on or otherwise provided by any kind of data carrier, and which might be executed in or by any suitable data processing unit. Software programs or routines are preferably applied to receive the measured values of the polarized signal components from the response signal, compare each of the components with corresponding values known or measured from the stimulus signal and then solve a linear equation system relating the components to each other.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIG. 1 shows a schematic illustration of a first embodiment of the present invention;

FIG. 2 show a schematic illustration of a second embodiment of the present invention;

FIG. 3 shows a signal spectrum with states of polarization each of the stimulus signal and the response signal that is generated by the system shown in FIG. 2.

### DETAILED DESCRIPTION OF EMBODIMENTS OF THE INVENTION

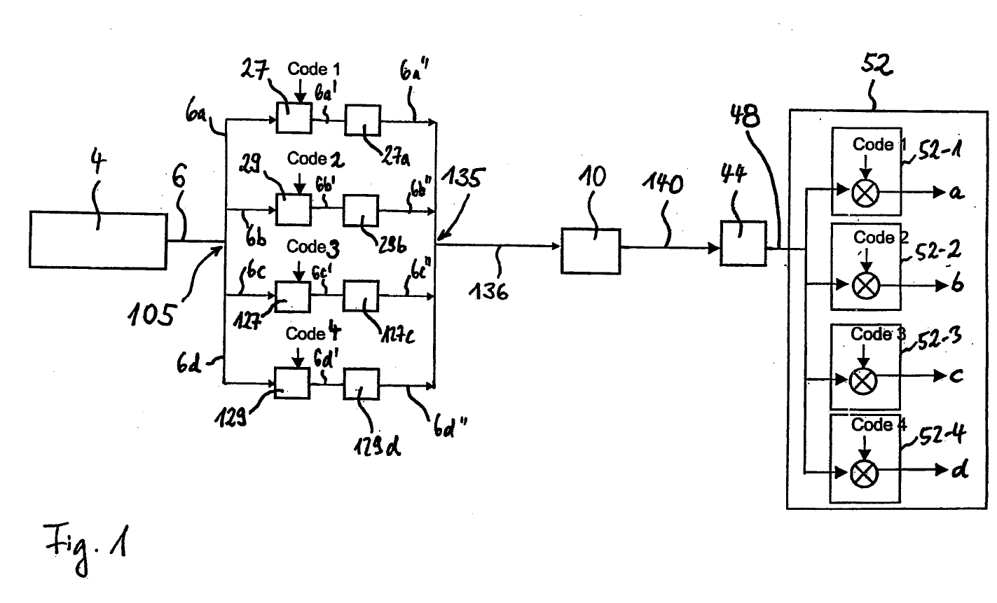

Referring now in greater detail to the drawings, FIG. 1 shows a schematic illustration of a first embodiment of the present invention providing a system for determining polarization dependent characteristic of an optical device under test 10 (DUT). According to this embodiment, an optical stimulus signal 6 of a TLS 4 is provided to a first coupler 105. The first coupler 105 has 4 output ports and splits the optical signal 6 into 4 parts 6a, 6b, 6c and 6d. Each signal part 6a, 6b, 6c and 6d is modulated by modulation units 27, 29, 127 and 129, respectively. The first signal 6a is modulated using a first binary code code 1, the second signal part is modulated using a second binary code code 2, the third signal part is modulated using a third binary code code 3, and the fourth signal part is modulated using a fourth binary code code 4. Codes 1, 2, 3 and 4 are orthogonal to each other.

Subsequently each coded signal 6a′, 6b′, 6c′, 6d′ receives a defined polarization by polarization controllers 27a, 29b, 127c, 129d in the path of the coded signal 6a′, 6b′, 6c′, 6d′, respectively. The resulting polarized signals 6a″, 6b″, 6c″, 6d″ are then combined at a coupler 135 and provided as a superimposed signal 136 to a DUT 10. As modulation units 27, 29, 127, 129 intensity modulators (e.g. LiNbO₃-based) can be used.

A response signal 140 leaving the DUT 10 is then detected at a detector 44. A detector signal 48 containing coded signals for main polarizations and cross polarization is then provided to a correlation unit 52 containing four correlators 52-1, 52-2, 52-3 and 52-4. Each correlator 52-1, 52-2, 52-3 and 52-4 is demodulating the signal 48 by multiplying signal 48 with the codes code 1, code 2, code 3 and code 4, respectively. The results of the demodulation is then provided by the correlation unit 52 at output ports a, b, c and d of the correlators 52-1, 52-2, 52-3 and 52-4, respectively.

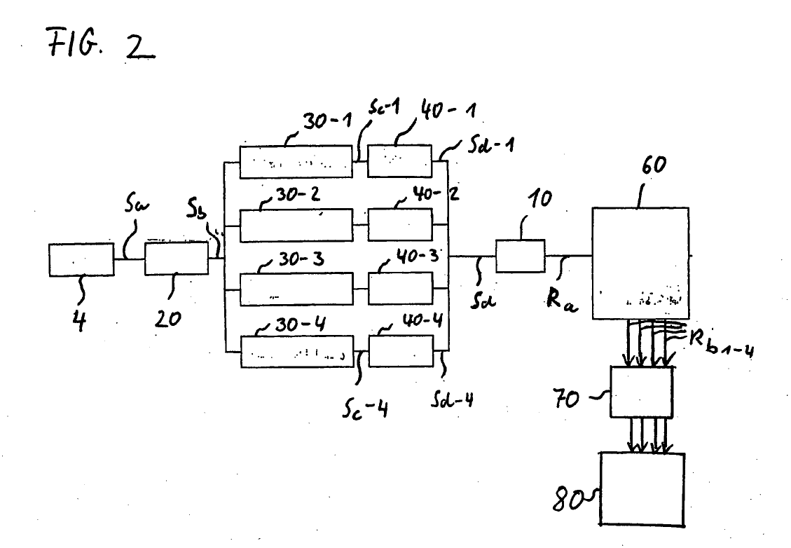

FIG. 2 shows a schematic representation of a second embodiment. An optical stimulus signal Sₐ is generated by a tunable laser source 4. The wavelength may be tuned over a limited wavelength range in order to investigate polarization effects of DUT 10 that further depend on wavelength.

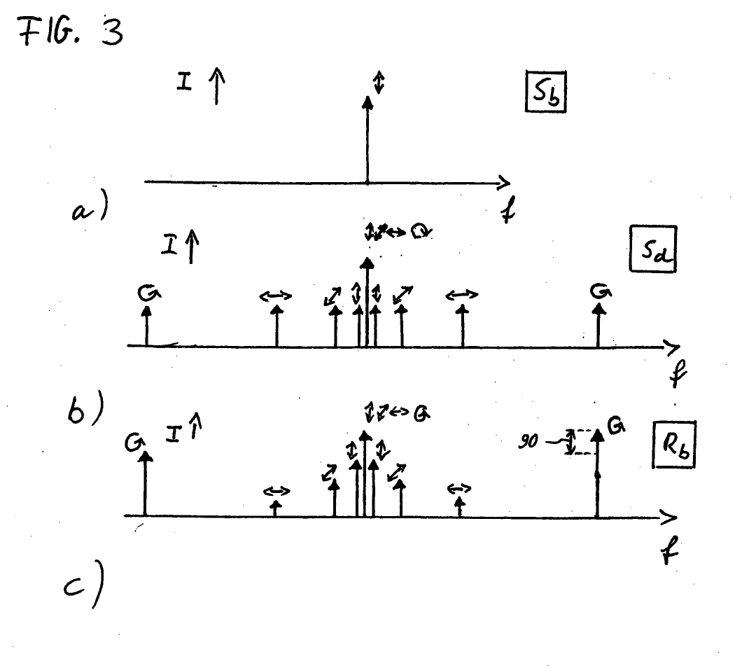

The stimulus signal Sₐ is input to a first polarization unit 20, which may be a polarization controller, for setting the signal into a predetermined state of polarization (signal S_{b}). This step is performed since optical modulation units such as a Mach-Zehnder based on LiNbO₃ as well as the subsequent polarization units generally work polarization dependent. Consequently, the influence of systematic errors on the measurement results can considerably be reduced. In this embodiment polarization controller 20 polarizes signal Sₐ linearly with angle 90 degrees. The resulting spectrum is depicted with its attached state of polarization in FIG. 3. The signal attains the form

Eᵢₙ(t)=E₀ cos(ω_{c}·t),

wherein ω_{c} is a carrier frequency.

The resulting signal S_{b} is then applied in parallel—or split—to each one of a set of modulation units 30-1 . . . 30-4. In this embodiment, a set of four modulation units is implemented. These modulation units modulate stimulus signal S_{b} by means of, e.g., amplitude, phase or frequency modulation. While the spectrum of polarized signal S_{b} is represented by one or more carrier frequencies, the corresponding carrier portion signal S_{b} is thus supplemented with each an unique identification portion to give modulated stimulus signals S_{c}-1 . . . S_{c}-4.

For example, a modulation frequency 1·ωₘ is applied to the stimulus signal S_{b} that enters modulation unit 30-1, and a modulation frequency of 4·ωₘ is applied to the stimulus signal S_{b} that enters modulation unit 30-2. Modulation units 30-3 or 30-4 apply identification portions with modulation frequencies of 16·ωₘ or 64·ωₘ, respectively, to the incoming stimulus signal S_{b}. These incommensurabilites of the multiplicators (1, 4, 16, 64) are chosen such as to inhibit mixture frequencies of different states of polarization when transforming optical signals into electrical signals. Other multiplication values might equally be chosen, such as (1, 3, 9, 27). An expression for stimulus signal S_{c}-1 is given by

$${E}_{mod} ( t ) = {E}_{0} \cdot ( cos ( {ω}_{C} \cdot t ) + \frac{m}{2} cos ( {ω}_{C} - {ω}_{m} ) + \frac{m}{2} cos ( {ω}_{C} + {ω}_{m} ) ) .$$

Each of the modulated stimulus signals is then forwarded to one of a set of polarization units 40-1 . . . 40-4, which each may be embodied, e.g., as a polarization controller. Stimulus signal S_{c}-1 is retained in its state of polarization, i.e. linear vertical)(90°) polarization. Stimulus signal S_{c}-2 is converted to linear diagonal)(45°) polarization, Stimulus signal S_{c}-3 is converted to linear horizontal)(0°) polarization, Stimulus signal S_{c}-4 is converted to circular polarization. Each of the four separated stimulus signals S_{c}-1 . . . S_{c}-4 now has a unique pair of modulation frequencies and states of polarization. The polarized, modulated signals are denoted as S_{d}-1 . . . S_{d}-4 in FIG. 3a.

Leaving the set of polarization units 40-1 . . . 40-4, the separated stimulus signals S_{d}-1 . . . S_{d}-4 are superimposed prior to being input to said DUT 10. The resulting frequency spectrum of modulated, polarized stimulus signal S_{d} is depicted in FIG. 3b.

A frequency selective receiver 60 receives a response signal Rₐ from DUT 10. As explained above said receiver 60 is adjustable in selecting desired frequency ranges by comprising an optical/electrical signal transformation unit (by means of, e.g., a semiconductor diode) with corresponding electrical filters having filter wavelength ranges according to the current needs. Accordingly, it becomes possible to select the identification portion of the transformed signal in order to trace and recover an indication of one of the stimulus signals S_{d}-1 . . . S_{d}-4 within the (electrically transformed) response signals R_{b}-1 . . . R_{b}-4.

It is clear to a person skilled in the art of optical communications measurement device techniques that instead of using one adjustable frequency selective receiver four or more frequency selective receivers 60 may be employed in parallel, each of them being fed with an input DUT response signal coming from a coupler, which splits the response signal Rₐ into at least four different parts.

Each signal measured by the power meter 70 (bandpass larger than 2 times the maximum of the modulation frequency) comprises the following frequency dependent characteristic signals:

$${I}_{2 ω mod , pol} ( t ) = {T}_{pol} \frac{{( {E}_{0} \cdot m )}^{2}}{2} cos ( 2 {ω}_{m} \cdot t ) ,$$

wherein Tₚₒₗ denotes a loss of power for the respective polarized signal (shown in FIG. 3c). By referencing to the previously performed calibration of the input signals, polarization dependent loss or gain coefficients can be evaluated by means of the Mueller method.

PDL is the maximum change in transmission of an optical component versus all possible input polarization states. As E₀ (e.g. by a similar measurement with a power meter prior to inputting the signal into the DUT 10) and ωₘ, are known and the intensity is measured, the polarization dependent characteristic of the DUT 10 can be derived.

An evaluation unit 80 extracts the measured power values and starts a detailed analysis of these results based on the concept of the Mueller matrix, which describes a transition of states of polarization due to, e.g., an optical element:

The power and state of polarization of an arbitrary signal may be fully represented by the Stokes Vector S=(S0, S1, S2, S3), wherein S0 represents the power, S1 the amount of linear horizontal polarization, S2 that of +/−45°linear horizontal polarization and S3 the amount of left or right hand circular polarization. The relation between the Stokes vector of the stimulus input signal and that of the output response signal can be expressed by a linear equation system which is represented by a 4×4 matrix, also called the Mueller-Matrix. For the reason that only the output power with respect each state of polarization is measured by means of power meter 70, and just the polarization dependent loss relating input and output powers to each other is searched for, just four coefficients of the Mueller Matrix are of interest here, i.e. are to be determined when solving the equation system.

A method of solving the equation system via the Mueller Matrix is provided in Hentschel, C. and Schmidt, S. in: “PDL Measurements using the Agilent 8169A Polarization Controller” (Product Note available via internet: http://cp.literature.agilent.com/litweb/pdf/5964-9937E.pdf), the content of which is fully incorporated here for reference. In particular, coincidentally measuring the four output power values of the response signal and relating them to the known four input powers, the whole state of polarization of the response signal can be characterized, i.e. the output signal Stokes vector can be fully determined in just one shot PDL-measurement.

1. A system adapted for determining polarization dependent characteristic of an optical device under test (10) having at least one input and at least one output, wherein at least four stimulus signals (S_{d}-1, S_{d}-2, S_{d}-3, S_{d}-4), each having a characteristic identification portion and a different state of polarization, are applied to said optical device under test (10), comprising:
a signal receiving unit (60) adapted for receiving a response signal (Rₐ) from said at least one output of said device under test, and being adapted to identify each of said identification portions or at least an indication thereof within said response signal (Rₐ),
an evaluation unit (80) adapted for determining said polarization dependent characteristic of said device under test (10) by evaluating said identification portions of said received response signal (Rₐ).

2. The system according to claim 1,
wherein said evaluation unit (80) is designed to provide a quantitative analysis of each of said identification portions representing a unique state of polarization within said response signal (Rₐ) with respect said stimulus signals.

3. A signal application unit adapted for applying at least four stimulus signals (S_{b}-1, S_{b}-2, S_{b}-3, S_{b}-4) each having a characteristic identification portion and a different state of polarization as an input to an optical device under test (10).

4. The signal application unit according to claim 3,
further comprising a signal source unit (4) for generating said stimulus signal (Sₐ), a coupler (105) for splitting said stimulus signal (Sₐ), a set of at least four polarization units (40-1, 40-2, 40-3, 40-4) for setting each of said split stimulus signals (S_{b}-1, S_{b}-2, S_{b}-3, S_{b}-4) into a different unique state of polarization, and a set of at least four modulation units (30-1, 30-2, 30-3, 30-4) for adding a characteristic identification portion to each of said split polarized stimulus signals (S_{c}-1, S_{c}-1, S_{c}-1, S_{c}-1).

5. The signal application unit according to claim 4,
wherein each of said modulation units (30-1, 30-2, 30-3, 30-4) is designed to apply at least one of a group comprising: phase modulation, amplitude modulation, frequency modulation to said stimulus signals (S_{c}).

6. A system adapted for determining polarization dependent characteristic of an optical device under test (10) having at least one input and at least one output, comprising:
a signal source unit (4) for inputting a stimulus signal (Sₐ, S_{b}) to each of at least four polarization units (40-1, 40-2, 40-3, 40-4);
said at least four polarization units (40-1, 40-2, 40-3, 40-4), each polarization unit setting said stimulus signals (S_{b}-1, S_{b}-2, S_{b}-3, S_{b}-4) into a unique state of polarization, wherein each of said polarization units (40-1, 40-2, 40-3, 40-4) is arranged to apply said uniquely polarized stimulus signals (S_{c}-1, S_{c}-2, S_{c}-3, S_{c}-4) to said at least one input of said device under test (10);
at least four modulation units (30-1, 30-2, 30-3, 30-4) for attaching a characteristic identification portion to each of said uniquely polarized stimulus signals (S_{c}-1, S_{c}-2, S_{c}-3, S_{c}-4), each of said modulation units (30-1, 30-2, 30-3, 30-4) being uniquely associated with one of said polarization units (40-1, 40-2, 40-3, 40-4),
a signal receiving unit (60, 70) adapted for receiving a response signal (Rₐ) from said at least one output of said device under test (10) and being adapted to identify said identification portion or at least an indication thereof within said response signal (Rₐ),
an evaluation unit (80) adapted for determining said polarization dependent characteristic of said device under test (10) by evaluating said identification portions of said received response signal (R_{b}).

7. The system according to claim 6,
wherein each of said modulation units (30-1, 30-2, 30-3, 30-4) is designed to apply a different modulation frequency to each of said stimulus signals (S_{c}-1, S_{c}-2, S_{c}-3, S_{c}-4) that is input to said polarization units (40-1, 40-2, 40-3, 40-4).

8. The system according to claim 6 or any one of the above claims, wherein said signal receiving unit comprises at least one frequency selective filter (60) for identifying said modulation frequency of at least one of said uniquely polarized stimulus signals (S_{c}-1, S_{c}-2, S_{c}-3, S_{c}-4) as said identification portion within said response signal (Rₐ).

9. The system according to claim 6 or any one of the above claims, wherein said signal receiving unit comprises a sensor and a power meter (70) associated with each of said frequency selective filters (60) of said receiving unit.

10. The system according to claim 6 or any one of the above claims, wherein a number of four or more polarization units (40-1, 40-2, 40-3, 40-4) each being associated with one of said modulation units (30-1, 30-2, 30-3, 30-4) are input with said stimulus signal, each of said polarization units (40-1, 40-2, 40-3, 40-4) generating one of a set comprising four or more distinct and unique states of polarization of said stimulus signal.

11. The system according to claim 10 or any one of the above claims, wherein said polarization units (40-1, 40-2, 40-3, 40-4) are designed such that the power of each of said polarized stimulus signals to be applied to said input of said device under test (10) attains substantially the same value.

12. The system according to claim 6 or any one of the above claims, wherein said evaluation unit (80) comprises a control unit, a memory and a user interface for solving a linear equation system that is input with values provided by said signal receiving unit which comprises a power meter (70).

13. The system according to claim 6 or any one of the above claims, wherein said signal application unit comprises a wavelength tunable laser source (4).

14. The system according to claim 6 or any one of the above claims, wherein said signal application unit comprises a further polarization unit for setting said stimulus signal into a predetermined state of polarization prior to inputting said signal to said plurality of polarization units (40-1, 40-2, 40-3, 40-4).

15. A determining system adapted for determining polarization dependent characteristic of an optical device under test (10) having at least one input and at least one output, wherein at least four stimulus signals (S_{d}-1, S_{d}-2, S_{d}-3, S_{d}-4), each having a characteristic identification and a different state of polarization, are applied to said optical device under test (10), comprising:
a signal receiving unit (60) adapted for receiving a response signal (Rₐ) from said at least one output of said device under test, and being adapted to identify signal portions, each corresponding to a respective one of the stimulus signals, within said response signal (Rₐ),
an evaluation unit (80) adapted for determining said polarization dependent characteristic of said device under test (10) by evaluating said signal portions of said received response signal (Rₐ).

16. The determining system according to claim 15,
wherein said evaluation unit (80) is designed to provide a quantitative analysis of each of said signal portions representing a unique state of polarization within said response signal (Rₐ) with respect said stimulus signals.

17. The determining system according to claim 15 or any one of the above claims,
wherein said signal receiving unit (60) is adapted to identify the signal portions by identifying the characteristic identifications of the stimulus signals within said response signal (Rₐ).

18. A signal application unit adapted for applying at least four stimulus signals (S_{b}-1, S_{b}-2, S_{b}-3, S_{b}-4) each having a characteristic identification and a different state of polarization as an input to an optical device under test (10).

19. The signal application unit according to claim 18, comprising at least one of the features:
a signal source unit (4) for generating an initial stimulus signal (Sₐ), a coupler (105) for splitting said initial stimulus signal (Sₐ) into at least four individual stimulus signals (S_{b}-1, S_{b}-2, S_{b}-3, S_{b}-4),
a signal source unit (4) for generating at least four individual stimulus signals (S_{b}-1, S_{b}-2, S_{b}-3, S_{b}-4),
a set of at least four polarization units (40-1, 40-2, 40-3, 40-4) for setting each of said individual stimulus signals (S_{b}-1, S_{b}-2, S_{b}-3, S_{b}-4) into a different unique state of polarization,
a set of at least four modulation units (30-1, 30-2, 30-3, 30-4) for adding a characteristic identification to each of said polarized stimulus signals (S_{c}-1, S_{c}-1, S_{c}-1).

20. The signal application unit according to claim 19,
wherein each of said modulation units (30-1, 30-2, 30-3, 30-4) is designed to apply at least one of a group comprising: phase modulation, amplitude modulation, frequency modulation to said stimulus signals (S_{c}).

21. A system adapted for determining polarization dependent characteristic of an optical device under test (10) having at least one input and at least one output, comprising:
a signal application unit according to claim 18 or any one of the above claims, adapted for applying at least four stimulus signals (S_{b}-1, S_{b}-2, S_{b}-3, S_{b}-4) each having a characteristic identification and a different state of polarization as an input to the optical device under test (10), and
a determining system according to claim 15 or any one of the above claims, adapted for determining polarization dependent characteristic of the optical device under test (10).

22. A system adapted for determining polarization dependent characteristic of an optical device under test (10) having at least one input and at least one output, comprising at least one of the features:
a signal source unit (4) adapted for providing at least one stimulus signal (Sₐ, S_{b})
at least four polarization units (40-1, 40-2, 40-3, 40-4), each adapted for receiving a respective stimulus signal, wherein each polarization unit (40-1, 40-2, 40-3, 40-4) is adapted for setting said respective stimulus signal (Sb-1, Sb-2, Sb-3, Sb-4) into a unique state of polarization;
at least four modulation units (30-1, 30-2, 30-3, 30-4) for providing a different characteristic identification to each one of said uniquely polarized stimulus signals (Sc-1, Sc-2, Sc-3, Sc-4);
a signal receiving unit (60, 70) adapted for receiving a response signal (Ra) from at least one output of said device under test (10) in response to the uniquely polarized stimulus signals (Sc-1, Sc-2, Sc-3, Sc-4), each having the respective characteristic identification, and being adapted to identify signal portions, each corresponding to a respective one of the stimulus signals, within said response signal (Ra),
an evaluation unit (80) adapted for determining said polarization dependent characteristic of said device under test (10) by evaluating said signal portions of said received response signal (Rb).

23. The system according to claim 22,
wherein each of said modulation units (30-1, 30-2, 30-3, 30-4) is designed to apply a different modulation frequency to each of said stimulus signals (S_{c}-1, S_{c}-2, S_{c}-3, S_{c}-4) that is input to said polarization units (40-1, 40-2, 40-3, 40-4).

24. The system according to claim 22 or any one of the above claims, wherein said signal receiving unit comprises at least one frequency selective filter (60) for identifying said modulation frequency of at least one of said uniquely polarized stimulus signals (S_{c}-1, S_{c}-2, S_{c}-3, S_{c}-4) as said identification within said response signal (Rₐ).

25. The system according to claim 22 or any one of the above claims, wherein said signal receiving unit comprises a sensor and a power meter (70) associated with each of said frequency selective filters (60) of said receiving unit.

26. The system according to claim 22 or any one of the above claims, wherein a number of four or more polarization units (40-1, 40-2, 40-3, 40-4) each being associated with one of said modulation units (30-1, 30-2, 30-3, 30-4) are input with said stimulus signal, each of said polarization units (40-1, 40-2, 40-3, 40-4) generating one of a set comprising four or more distinct and unique states of polarization of said stimulus signal.

27. The system according to claim 22 or any one of the above claims, wherein said polarization units (40-1, 40-2, 40-3, 40-4) are designed such that the power of each of said polarized stimulus signals to be applied to said input of said device under test (10) attains substantially the same value.

28. The system according to claim 22 or any one of the above claims, wherein said evaluation unit (80) comprises a control unit, a memory and a user interface for solving a linear equation system that is input with values provided by said signal receiving unit which comprises a power meter (70).

29. The system according to claim 22 or any one of the above claims, wherein said signal application unit comprises a wavelength tunable laser source (4).

30. The system according to claim 22 or any one of the above claims, wherein said signal application unit comprises a further polarization unit for setting said stimulus signal into a predetermined state of polarization prior to inputting said signal to said plurality of polarization units (40-1, 40-2, 40-3, 40-4).

31. An apparatus for polarization dependent analyzing an optical signal (6) transmitted through a DUT (10), comprising:
a first beam splitter (105) splitting the optical signal (6) into a first signal part (6a) having an initial first, polarization, a second signal part (6b) having an initial second polarization, a third signal part (6c) having an initial third polarization and a fourth signal part (6d) having an initial fourth polarization,
a first modulator (27) coding the first signal part (16, 6a) using a first code (17, code 1),
a second modulator (29) coding the second signal part (20, 6b) using a second code (17, code 2),
a third modulator (127) coding the third signal part (6c) using a third code (code 3),
a fourth modulator (129) coding the fourth signal part (6d) using a fourth code (code 4),
a coupler (35, 135) connected to the modulators (27, 29, 127. 129), which is designed to reunite the coded signal parts (6a, 6b, 6c, 6d) and to provide the first (6a), the second (6b), the third (6c) and the fourth coded signal parts (6d) to the DUT (10),
a detector (44, 46) detecting a DUT-signal (140) coming from the DUT (10) in response to the coded signal parts (6a, 6b, 6c, 6d),
a first correlator (52-1, 52-3) determining a first signal part (a, c) of the DUT-signal (140) corresponding to the first signal part (6a) by means of the first code (17, code 1), and
a second correlator (52-2, 52-4) determining a second part (b, d) of the DUT-signal (32, 140) corresponding to the second signal part (20, 6b) by means of the second code (17, code 2).
a third correlator (52-3) determining a third signal part (c) of the DUT-signal (140) corresponding to the third signal part (6c) by means of the third code (code 3), and
a fourth correlator (52-4) determining a fourth part (d) of the DUT-signal (140) corresponding to the fourth signal part (6d) by means of the fourth code (code 4).

32. The apparatus according to claim 31, further comprising
an evaluation unit adapted for determining said polarization dependent characteristic of said device under test from said first, said second, said third part and said fourth part of said DUT-signal.

33. A method of polarization dependent analyzing an optical signal (6) provided to a DUT (10), comprising the steps of:
splitting the optical signal (6) at least into a first signal part (16, 6a) having an initial first polarization, a second signal part (20, 6b) having an initial second polarization, a third signal part (6c) having an initial third polarization and a fourth signal part (6d) having an initial fourth polarization,
coding the first signal part (6a) using a first code (17, code 1), coding the second signal part (6b) using a second code (19, code 2), coding the third signal part (6c) using a third code (code 3) and coding the fourth signal part (6d) using a fourth code (code 4),
providing the first (16, 6a), the second (20, 6b), the third (6c) and the fourth coded signal parts (6d) to the DUT (10),
detecting a DUT signal (140) coming from the DUT (10) in response to the coded signal parts (6a, 6b, 6c, 6d)) and
determining a first part (a, c) of the DUT-signal (140) corresponding to the first signal part (6a) by means of the first code (17, code 1) and determining a second part (b, d) of the DUT-signal (140) corresponding to the second signal (6b) by means of the second code (19, code 2) and determining a third part (c) of the DUT-signal (140) corresponding to the third signal part (6c) by means of the third code (code 3) and determining a fourth part (d) of the DUT-signal (140) corresponding to the fourth signal part (6d) by means of the fourth code (code 4).

34. Method of determining polarization dependent characteristic of an optical device under test having at least one input and at least one output, comprising the steps of:
generating, splitting and inputting a stimulus signal (Sₐ, S_{b}) to each of at least four polarization units (30-1, 30-2, 30-3, 30-4);
setting each of said input stimulus signals (S_{b}-1, S_{b}-2, S_{b}-3, S_{b}-4) into a unique state of polarization;
attaching a characteristic identification portion to each of said input and/or polarized stimulus signals (S_{c}-1, S_{c}-2, S_{c}-3, S_{c}-4);
applying said stimulus signal (S_{d}-1, S_{d}-2, S_{d}-3, S_{d}-4) to said device under test (10) for effecting a response signal (Rₐ) of said device under test (10);
receiving and identifying each of said characteristic identification portions from said response signal for tracing each of said polarized stimulus signals within said response signal;
deriving a polarization dependent characteristic of said device under test from said traced polarized stimulus signals (R_{b}-1, R_{b}-2, R_{b}-3, R_{b}-4).

35. The method according to claim 34, wherein said characteristic identification portion is applied to said stimulus signal (S_{c}-1, S_{c}-2, S_{c}-3, S_{c}-4) by means of frequency, amplitude or phase modulation.

36. The method according to claim 34 or any one of the above claims, wherein said polarization dependent characteristic to be determined is represented by a characteristic polarization dependent loss/gain of power of said device under test (10).

37. The method according to claim 34 or any one of the above claims, wherein a set of at least four polarization units (30-1, 30-2, 30-3, 30-4) are employed to set said stimulus signal (S_{b}-1, S_{b}-2, S_{b}-3, S_{b}-4) each into a different state of polarization, and wherein each of said differently polarized stimulus signals (S_{d}-1, S_{d}-2, S_{d}-3, S_{d}-4) is applied to an input of said device under test while superimposing said polarized stimulus signals with each other.

38. The method according to claim 34 or any one of the above claims, wherein
four or more different states of polarization are generated and independently applied to said stimulus signal (S_{b}-1, S_{b}-2, S_{b}-3, S_{b}-4);
the power of each of said polarized stimulus signals (S_{d}-1, S_{d}-2, S_{d}-3, S_{d}-4) as input to said optical device under test is measured;
the power of each of said response signals (R_{b}-1, R_{b}-2, R_{b}-3, R_{b}-4) as identified and traced from said polarized stimulus signals (S_{d}-1, S_{d}-2, S_{d}-3, S_{d}-4) within said response signal by means of the respective identification portion, is measured;
for each state of polarization, the power measured from said signals as input to (Sd-1, Sd-2, Sd-3, Sd-4) and as output from (Rb-1, Rb-2, Rb-3, Rb-4) said optical device (10) are compared with each other.

39. The method according to claim 34 or any one of the above claims, wherein the step of comparing the power measured from signals as input to (S_{d}-1, S_{d}-2, S_{d}-3, S_{d}-4) and as output from (R_{b}-1, R_{b}-2, R_{b}-3, R_{b}-4) said device under test (10) involves solving a linear equation system.

40. The method according to claim 34 or any one of the above claims, wherein said linear equation system is represented by a Mueller-Matrix.

41. A software program or product, preferably stored on a data carrier, for executing the method of any one of above claims, when run on a data processing system such as a computer.
